(19) United States
(12) Patent Application Publication
(10) Pub. No.: US 2014/0152009 A1
(43) Pub. Date: Jun. 5, 2014

(54) COMPLEMENTARY POWER AND FREQUENCY CONTROL FOR POWER GENERATING EQUIPMENT

(71) Applicant: United Technologies Corporation, Hartford, CT (US)

(72) Inventors: Richard P. Meisner, Glastonbury, CT (US); Ruurd A. Vanderleest, Vernon, CT (US)

(73) Assignee: United Technologies Corporation, Hartford, CT (US)

(21) Appl. No.: 14/091,703

(22) Filed: Nov. 27, 2013

Related U.S. Application Data
(60) Provisional application No. 61/732,091, filed on Nov. 30, 2012.

(51) Int. Cl. H02P 9/00

(52) U.S. Cl. CPC H02P 9/00
USPC 290/7

(57) ABSTRACT

A controller for a power generating system that includes an engine and a generator, wherein the engine provides mechanical force to the generator, which converts the mechanical force to electrical energy that is distributed via a distribution network. The controller includes a complementary filter that applies a low-frequency response to changes in the monitored power output and a high-frequency response to changes in the monitored grid frequency. The complementary filter combines outputs of the high-frequency response and low-frequency response to generate a process variable. A feedback controller generates a fuel flow value in response to the process variable.

### BACKGROUND

The present invention is applicable to power generating systems and in particular to controllers used to regulate the operation of power generating systems.

Power generating systems typically include an engine and generator set sometimes referred to as a “genset”. The engine provides mechanical energy to a prime mover. The generator converts the mechanical energy provided by the prime mover to electrical energy that is supplied to a distribution network for distribution to an electric power consumer. A controller associated with the generator monitors the operation of the engine and generator and in response varies the fuel flow of the engine to increase or decrease the power supplied by the generator. The controller may regulate the engine and generator based on parameters such as power turbine speed (e.g., grid frequency) or electrical power output. In applications in which the generating system is attached to a “rigid” distribution network, in which a large generating systems maintains a relatively inflexible grid frequency, variations in frequency are unusual and typically cannot be modified by a relatively small (as compared with large generating systems) power generating system such as a ground-based turbine power generating system. As a result, controllers associated with gensets attached to paralleled distribution networks do not typically regulate based on frequency. In isolated systems, in which a single power generating system is the only supplier of power, frequency may be used to regulate the operation of the engine. However, in most applications in which a plurality of power generating systems are paralleled together, frequency can not be used to regulate the operation of the engine without creating imbalances between the power supplied by each power generating system.

With no mechanism for regulating frequency, power generating system employed in small, “flexible” grid applications may experience more variation in grid frequency. While these generating systems may employ “droop” control to ensure proper load sharing among parallel power generating systems in response to frequency changes, droop control does not act to regulate the frequency to a nominal or desired value. It would therefore be desirable to provide regulation of both the power output of a power generating system and the grid frequency.

### SUMMARY

A controller for a power generating system that includes an engine and a generator, wherein the engine provides mechanical force to the generator, which converts the mechanical force to electrical energy that is distributed via a distribution network. The controller includes a complementary filter that applies a low-frequency response to changes in the monitored power output and a high-frequency response to changes in the monitored grid frequency. The complementary filter combines outputs of the high-frequency response and low-frequency response to generate a process variable. A feedback controller generates a fuel flow value in response to the process variable.

### BRIEF DESCRIPTION OF THE DRAWINGS

FIG. 1 is a block diagram of a power generation system according to an embodiment of the present invention.

FIG. 2 is a block diagram of operations performed by a controller to implement complementary control according to an embodiment of the present invention.

FIG. 3 is a block diagram illustrating operations performed by an operating point converter to convert a nominal power request expressed in units of power to an operating point expressed in units of frequency according to an embodiment of the present invention.

FIG. 4 is a block diagram illustrating operations performed by a real power setpoint calculator to calculate a setpoint value that accounts for actual grid frequency.

FIG. 5 is a block diagram illustrating operations performed by a real power calculator to compare a setpoint value to a monitored power value provided in feedback to a controller to generate a power error signal represented in units of speed according to an embodiment of the present invention.

FIG. 6 is a block diagram illustrating operations performed by a complementary filter according to an embodiment of the present invention.

### DETAILED DESCRIPTION

The present invention is applicable to power generation systems deployed to supply power to more ‘flexible’ power distribution networks (i.e., networks that lack a large power generation system that maintains rigid grid frequency). The controller associated with the generating system utilizes a complementary control system that employs a high frequency response to grid frequency transients and a low frequency response to output power, such that grid frequency transients are responded to quickly to maintain grid frequency at a nominal level while still providing the desired output power regulation.

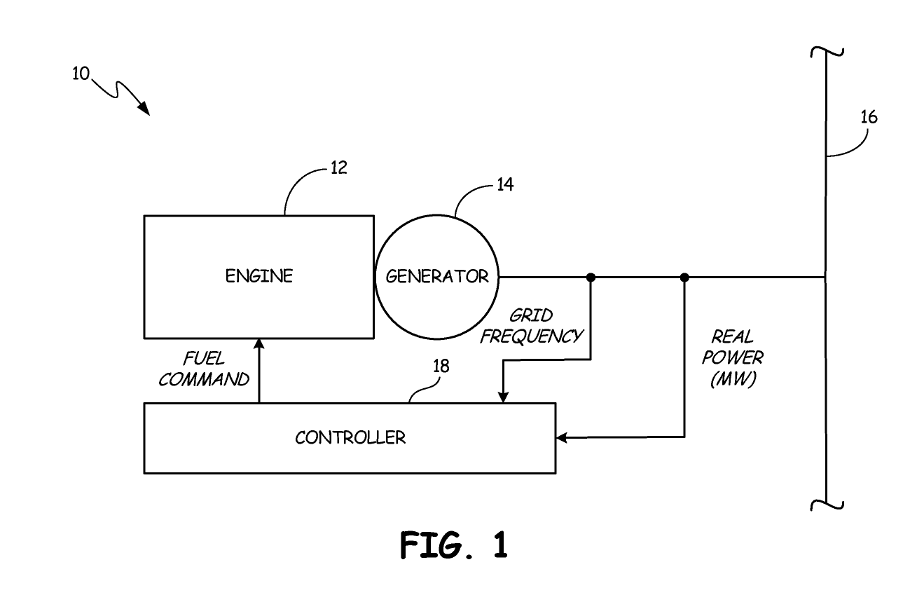

FIG. 1 is a block diagram of power generating system 10 according to an embodiment of the present invention. Power generating system 10 includes engine 12, generator 14, distribution network 16, and controller 18. Engine 12, generator 14, and controller 18 collectively form a generator set (i.e., genset). Typically, a plurality of similar and/or dissimilar gensets are paralleled together to provide the desired power capacity to distribution network 16. Engine 12 may be any device capable of supplying mechanical power to generator 14. For example, in one embodiment, engine 12 is a land-based turbine engine.

Generator 14 is connected to receive mechanical energy supplied by engine 12, and converts the received mechanical energy to electrical energy that is supplied to distribution network 16. Controller 18 monitors the real power provided by generator 14, expressed in mega-watts (MW), as well as the grid frequency, represented in revolutions per minute (rpm). In an exemplary embodiment, controller 18 may monitor the grid frequency directly via monitoring of the output of generator 14 or may derive the grid frequency by monitoring the speed of engine 12, wherein the speed (e.g., revolutions per minute) of engine 12 determines the output frequency of generator 14. Once the genset is connected to distribution network 16, the monitored speed is representative of grid frequency. The term grid frequency is used throughout, even though grid frequency itself is typically not monitored directly, but rather inferred from monitored speed.

Controller 18 implements a complementary control algorithm that provides a high-frequency response (i.e., fast response) to transient changes in grid frequency as represented by the monitored speed input, as well as a low-frequency response (i.e., slower response) to changes in the output power. In response to the monitored inputs, controller 18 regulates the fuel command to either increase or decrease the mechanical power supplied to generator 14, thereby increasing or decreasing the power supplied by generator 14.

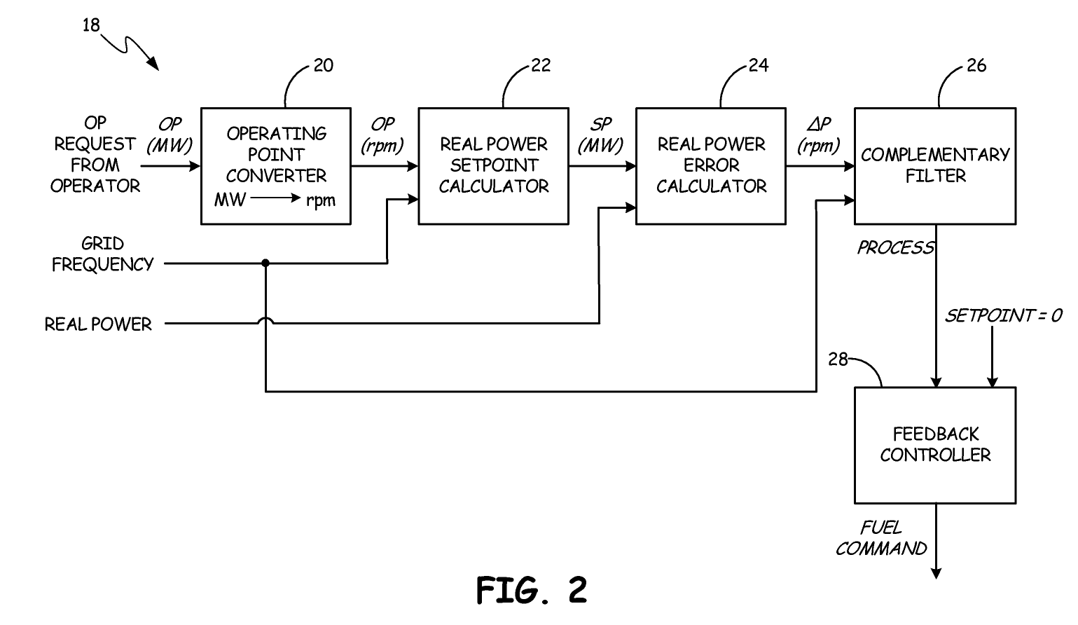

FIG. 2 is a block diagram of operations performed by controller 18 to implement complementary proportional-integral-derivative (PID) control according to an embodiment of the present invention. Inputs received by controller 18 include an operating point request from an operator OP(MW), grid frequency (derived from monitored speed), and real power provided by the generator. The inclusion of (MW) after the operating input OP denotes the units in which the request is expressed, which in this case is mega-watts (MW).

Operating point converter 20 converts the operating point request OP(MW) from being expressed in terms of desired mega-watts (MW) to an operating point request expressed in frequency OP(rpm), wherein rpm signifies revolutions per minute. The conversion is based on the well-known concept of droop control, in which paralleled generators, which cannot normally communicate with one another, agree to a droop curve defined as full-load at a particular speed (e.g., 100%) and no-load at a higher speed (e.g., 105%). Based on a selected droop curve, the operating point request OP(MW) can be expressed in terms of frequency OP(rpm). Droop control ensures that loads are distributed among each of the plurality of parallel connected generators equally in response to variations in grid frequency, but does not result in regulation of the grid frequency.

Real power setpoint calculator 22 generates a setpoint value based on the operating point request OP(rpm) and the monitored grid frequency. Real power setpoint calculator 22 provides part of the low-frequency response because if the grid frequency does not return to a nominal or desired frequency then principles of droop control will act to modify the setpoint SP(MW) so that the output power request will deviate from the operator point request OP(MW). As discussed above, droop control is well-known in the art of generating control systems, and is often-times used to ensure load balancing among a plurality of paralleled generating systems.

Real power error calculator 24 compares the setpoint value SP(MW) provided by real power setpoint calculator 22 to the monitored power output of generator 14 to generate a difference or error signal ΔP(rpm) that is represented in units of frequency.

Complementary filter 26 receives the power error output ΔP(rpm) provided by real power error calculator 24 and grid frequency. Complementary filter 26 includes a high-frequency path or response that responds to transient changes in grid frequency and a low-frequency path that regulates the output power of generator 14. As a result, the frequency error is provided as an input to the high-frequency response portion of complementary filter 26, while the power error output ΔP(rpm) is provided as an input only to the low-frequency response portion of complementary filter 26. The output of the low-frequency response portion and the high-frequency response portion of complementary filter 26 are combined to generate a process value that is provided as an input to feedback controller 28. In the embodiment shown in FIG. 2, feedback controller 28 is a proportional-integral-derivative (PID) controller that generates a fuel command that acts to minimize the difference between the process variable and the setpoint (i.e., set equal to ‘0’).

In this way, controller 18 regulates the output power as desired and required in most generating system applications, but in addition provides a complementary, high-frequency response to grid frequency transients that acts to return the grid frequency to a steady state value.

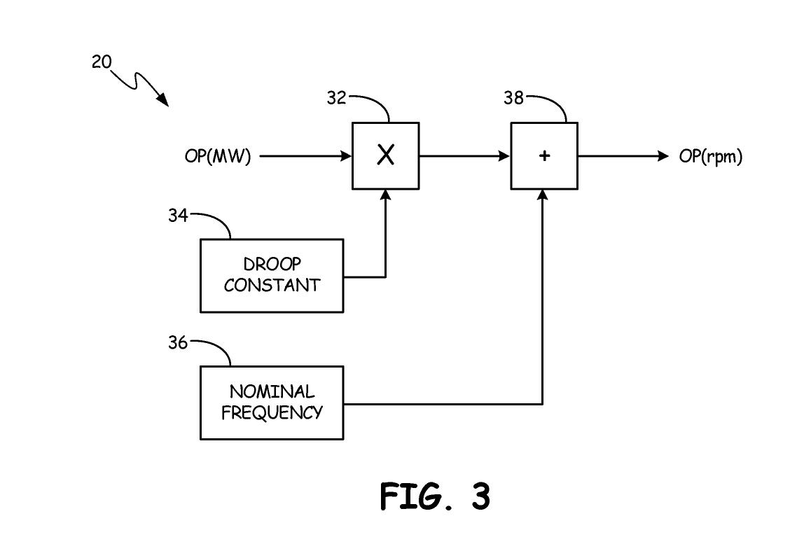

FIG. 3 is a block diagram illustrating operations performed by operating point converter 20 to convert a nominal power request expressed in mega-watts (MW) to an operating point expressed in revolutions per minute (rpm) according to an embodiment of the present invention. In particular, the nominal power request OP(MW) is multiplied at multiplier block 32 by a droop constant. For example, generators typically operate with a 4-5% droop. If operating at a 4% droop, this means that the generating system has a full-load speed of 100% and a no-load speed of 104%. The resulting ratio defining the rate at which changes in speed will result in changes in the power request is the droop constant and is expressed in units of (rpm/MW). For example, in a generating system in which a full power output is 30 MW and the full-load speed is 3000 rpm, a 4% droop would result in a droop constant of 4 rpm/MW.

Multiplying the nominal power request OP(MW) by the droop constant 34 converts the nominal power request from units of power (MW) to units of frequency (rpm). To account for start-up operations, in which the generate is brought up to speed before generating any real power, a nominal frequency value 36 (representative of a desired speed) is added to the nominal power request to provide regulation of engine speed prior to connection of generator 14 to distribution network 16 to generate an operating power request OP(rpm), expressed in terms of grid frequency.

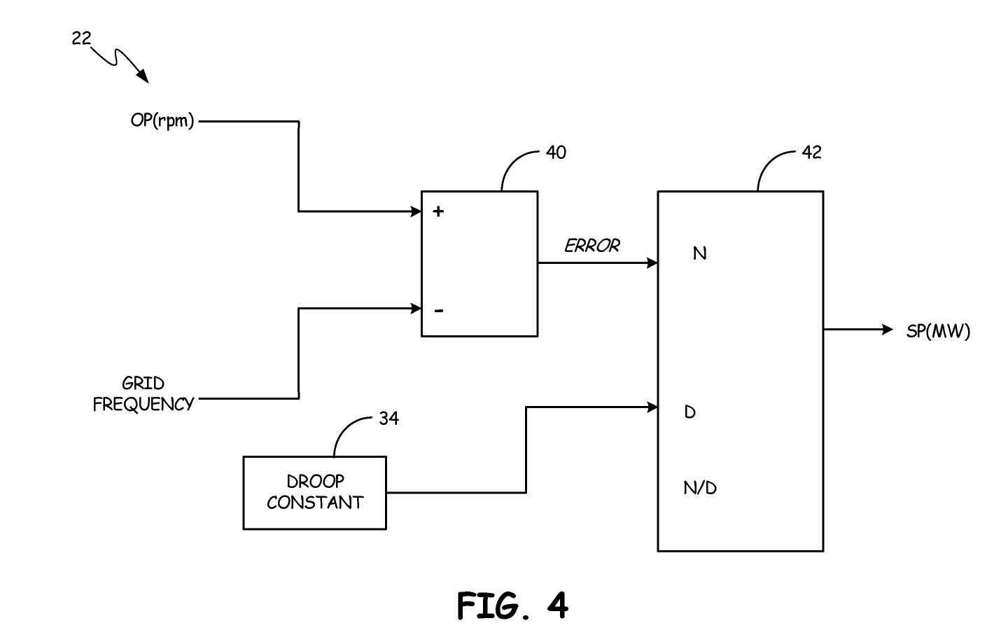

FIG. 4 is a block diagram illustrating operations performed by real power setpoint calculator 22 to convert the operating point OP(rpm) to a setpoint value that accounts for the current grid frequency. In particular, the operating point OP(rpm) provided by operating point converter 20 is compared to the monitored grid frequency by difference block 40 to generate an error signal. The error value represents a difference between the operating power requested by the operator (expressed in terms of grid frequency) and the actual grid frequency, both of which have units of rpm's. Divider block 42 divides the error signal by the droop constant 34 (same constant described with respect to FIG. 3) to convert the error value from units of frequency to units of power. The resulting setpoint value SP(MW) is part of the low-frequency response to changes in grid frequency. For example, if grid frequency remains greater than or less than a nominal value (represented by operating point OP (rpm)), the principles of droop will bias the setpoint value SP(MW). In this way, the setpoint value SP(MW) is biased by the grid frequency before being provided to real power calculator 24.

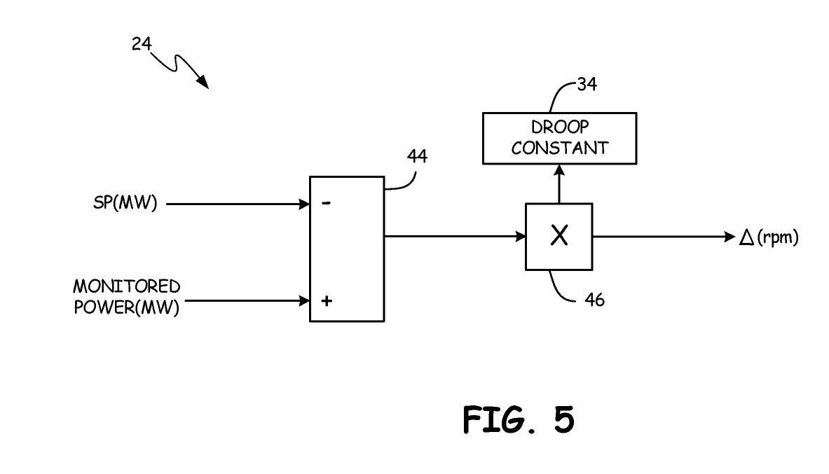

FIG. 5 is a block diagram illustrating operations performed by real power calculator 24 to compare the setpoint value SP(MW) to the monitored power value provided in feedback to controller 18 to generate an error signal ΔP(rpm) once again represented in units of frequency. In particular, difference block 44 compares the setpoint value SP(MW) with the monitored power (MW), both having units of mega-watts. The output represents the error between the desired power value (e.g., setpoint value SP(MW)) and the monitored power output. Multiplier block 46 multiplies the error value by droop constant 34 to convert the error value from units of power (MW) to units of frequency.

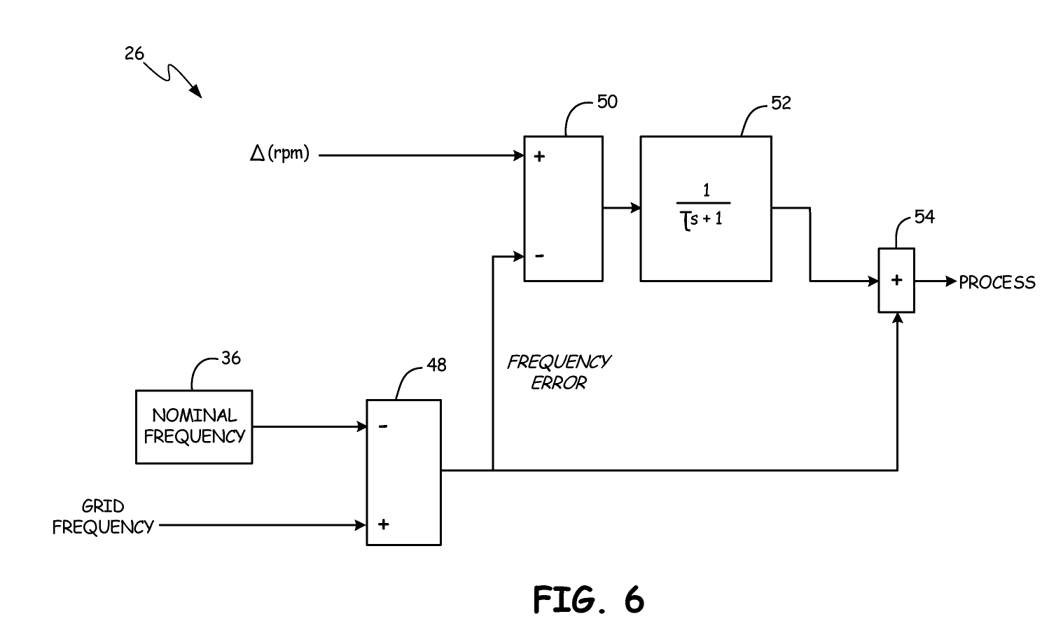

FIG. 6 is a block diagram illustrating operations performed by complementary filter 26 according to an embodiment of the present invention. Complementary filter 26 receives as inputs the error value generated by real power calculator 24 as well as the monitored grid frequency. In the embodiment shown in FIG. 6, difference block 48 compares the grid frequency to a nominal or desired grid frequency 36. The output is a frequency error that represents the difference between the desired grid frequency and the actual grid frequency. Therefore, complementary filter 26 utilizes a frequency error value and a power error value, represented by the previously calculated power error value A(rpm). The frequency error value is combined with the power error value ΔP(rpm) as part of the low frequency response, which is implemented by difference block 50 and low-pass filter 52. Both the power error value ΔP(rpm) and the frequency error value are represented in units of rpm's, and can therefore be directly compared to one another. The result of the difference is provided to low-pass filter 52, which filters high-frequency and/or transient components to provide a low-frequency response.

In addition, the frequency error generated by difference block 48 is also provided directly to the output of complementary filter 26 by combining the frequency error with the output of the low-frequency response path. That is, the frequency error signal has a direct path to the complementary filter output without an intervening low-pass filter. In this way, complementary filter 28 provides a high-frequency response to transients in the monitored grid frequency.

Summer 54 combines the high-frequency response and the low-frequency response to generate a process value is provided as an input to feedback controller 28. In response to the process value, feedback controller 28 generates a fuel control command that increases/decreases the power provided by engine 12.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A power generating system comprising:
an engine connected to generate mechanical power;
a generator connected to convert mechanical power provided by the engine to electrical power for distribution via a distribution grid; and
a controller that regulates operation of the engine based on monitors output power of the generator and grid-frequency, wherein the controller employs a complementary control algorithm that provides a high-frequency response to changes in grid-frequency and a low-frequency response to changes in output power and in response regulates the operation of the engine to maintain a desired output power and grid-frequency of the generator.

2. The power generating system of claim 1, wherein the complementary control algorithm includes:
a high-frequency response path that calculates a difference between the monitored grid frequency with a desired grid frequency to generate a grid frequency error value that represents a high-frequency response to changes in grid frequency;
an low-frequency response path that calculates a difference between the output power error value and the grid frequency error value and applies a low-pass filter to the difference to generate the low-frequency response to changes in output power; and
a summer block that sums the high-frequency response to changes in grid frequency with the low-frequency response to changes in output power to provide a process variable.

3. The power generating system of claim 2, wherein the controller further includes:
a proportional-integral-derivative (PID) controller that generates a fuel flow value provided to control operation of the engine in response to the process variable provided by the summer block.

4. The power generating system of claim 1, wherein the controller further includes:
an operating point converter than converts a nominal operating point request from units of power to units of frequency;
a real power setpoint calculator that generates an operating point request that accounts for monitored grid frequency; and
a real power error calculator that compares the operating point request provided by the real power setpoint calculator to the monitored power to generate the power error value provided as an input to the complementary control algorithm.

5. A method of regulating grid frequency and output power in a power generation system, the method comprising:
monitoring grid frequency;
monitoring output power of the power generation system; and
applying a complementary control algorithm that includes a high-frequency response to changes in the monitored grid frequency and a low-frequency response to changes in the monitored output power.

6. The method of claim 5, wherein applying the complementary control algorithm includes:
calculating a power error value that represents a difference between the monitored output power and a requested output power;
calculating a grid frequency error value that represents a difference between the monitored grid frequency and desired grid frequency;
applying the power error value to the low-frequency response of the complementary control algorithm and the grid-frequency error value to the high-frequency response of the complementary control algorithm.

7. The method of claim 6, wherein applying the power error value to the low-frequency response of the complementary control algorithm further includes:
calculating a difference between the power error value and the grid-frequency error value and applying the difference to a low-pass filter to generate the low-frequency response of the complementary control algorithm.

8. The method of claim 7, wherein applying the complementary control algorithm includes summing an output of the low-frequency response with an output of the high-frequency response to generate an output of the complementary control algorithm.

9. The method of claim 8, further including applying proportional-integral-derivative (PID) control to the output of the complementary control algorithm to generate a fuel flow value used to regulate operation of the generator.

10. A controller for a power generating system that includes an engine and a generator, wherein the engine provides mechanical force to the generator, which converts the mechanical force to electrical energy that is distributed via a distribution network, the controller comprising:
a complementary filter that applies a low-frequency response to changes in the monitored power output and a high-frequency response to changes in the monitored grid frequency, wherein the complementary filter combines outputs of the high-frequency response and low-frequency response to generate a process variable; and
a feedback controller that generates a fuel flow value in response to the process variable.

11. The controller of claim 10, wherein the complementary filter includes:
a high-frequency response path that calculates a difference between the monitored grid frequency and a desired grid frequency to generate a grid frequency error value that represents a high-frequency response to changes in grid frequency;
an low-frequency response path that calculates a difference between the output power error value and the grid frequency error value and applies a low-pass filter to the difference to generate the low-frequency response to changes in output power; and
a summer block that sums the high-frequency response to changes in grid frequency with the low-frequency response to changes in output power to provide a process variable.

12. The controller of claim 11, wherein the feedback controller is a proportional-integral-derivative (PID) controller that generates a fuel flow value provided to control operation of the engine in response to the process variable provided by the summer block.

13. The controller of claim 10, further including:
an operating point converter than converts a nominal operating point request from units of power to units of frequency;
a real power setpoint calculator that generates an operating point request that accounts for monitored grid frequency; and
a real power error calculator that compares the operating point request provided by the real power setpoint calculator to the monitored power to generate the power error value provided as an input to the complementary filter.
